(19) United States
(12) Patent Application Publication
(10) Pub. No.: US 2011/0096239 A1
(43) Pub. Date: Apr. 28, 2011

(54) Temporary Memory Circuits for Matrix Display Device

(75) Inventors: Dwayne Charles Burns, County Down (GB); Robert Johnstone Woodburn, Edinburgh (GB); Mark Ian Newsam, Peebles (GB); Jonathan Ephraim David Hurwitz, Edinburgh (GB)

(73) Assignee: MICROEMISSIVE DISPLAYS LIMITED, Edinburgh (GB)

(21) Appl. No.: 12/095,354

(22) PCT Filed: Nov. 30, 2006
(86) PCT No.: PCT/GB2006/004470

§ 371 Date: Dec. 8, 2009

(30) Foreign Application Priority Data
Nov. 30, 2005 (GB) 0524400.9

(51) Int. Cl. H04N 9/64

(52) U.S. Cl. 348/715; 348/E09.037

(57) ABSTRACT

A circuit for supplying video data supplied in frames divided into timeslots to an array of pixels comprises a plurality of one-bit temporary storage elements (M), at least some of which are arranged to store data for different pixels of the array during different timeslots within a frame. The circuit can be used in an electroluminescent display in which each pixel (P) comprises an organic light-emitting diode.

### BACKGROUND TO THE INVENTION

This invention relates to optoelectronic display apparatus. The invention provides circuits for temporary storage of frames of data prior to display thereof.

A known electronic display, and in particular a microdisplay, consists of an array of individually addressable picture elements (pixels). In some applications, these arrays function in binary mode, where each individual pixel receives either an ON or OFF signal. The signal at the pixel is used to modulate or emit light via an overlying electro-optic material. Typically, the pixels of the array that receive the ON signal form the image the viewer receives, either directly, or magnified via some optics.

In the context of organic light emitting device (OLED) microdisplays, a digital approach to controlling the small currents required is favored as it is extremely difficult to successfully control greyscale in microdisplay pixels by varying the current magnitude. By using a digital approach, the pixel driver current source can be designed and optimized for the maximum current required, rather than for a continuum between maximum and minimum.

Pulse width modulation is a well-known technique for generating greyscale on binary mode electronic displays. Each frame of greyscale video to be displayed on the pixel array is split into a number of time-sequential subframes, or bitplanes. In order to minimize the number of bits required to represent a set of grey levels, the bitplanes are typically binary-weighted with respect to each other. By rapidly scanning the bitplanes into the pixel array, and allotting a binary weighted number of timeslots to each bitplane, the human eye effectively integrates the bitplanes to produce the illusion of a greyscale image. Note that pulse width modulation schemes typically use the video line synchronization signal to control the timing of the modulation sequence, although this is not necessary.

In a typical binary mode electronic display implementation, each pixel in a pixel array can store and display a single bit of information. If the information source is a streaming video source, a temporary memory store is required to help format the data appropriately into bitplanes before it is loaded onto the pixel array. The temporary memory store can be implemented inside or outside the microdisplay. The temporary memory store typically has to have enough memory elements to hold at least one complete frame of data, where each memory element has enough bits to represent the desired number of greyscale levels to be displayed by a pixel. For example, to achieve 256 gray levels (8-bit) using pulse width modulation on a 320×240 pixel array, where each pixel has a 1-bit storage element, a temporary memory store with 614,400 (320*240*8) 1-bit memory cells would be required:

Once a frame of data has been loaded into the temporary memory store, the data can be transferred to the pixel array one bitplane at a time. A complication is that bitplane data must be read out of the temporary memory store in a bursty manner, in order to use up as small a proportion of the frame time as possible. This typically results in increased operating frequency and power dissipation for the electronic display system.

A further complication is that the temporary memory store typically holds data for two complete frames. This permits the incoming video stream to be transferred into one half of the temporary memory store, while data is transferred out of the other half of the temporary memory store to the pixel array. An alternative is to use a dual-port temporary memory store, from which data can be written to, and read from, simultaneously.

The temporary memory store can be quite a significant fraction of the cost of the complete electronic display system. If implemented on-chip, it can occupy quite a significant proportion of the overall chip size.

The bursty nature of transferring the bitplane data from the temporary memory store can be eliminated by providing two memory elements in each pixel, so that a new bitplane can be loaded into one of the memory elements in each pixel, while the values in the other memory element of each pixel is displayed. However, this increases the area requirements of the pixel, and thus the cost of the display component.

An alternative approach, disclosed in WO 02/089534, is to provide enough storage elements in each pixel for all the bits required to generate a particular number of grey levels, then cyclically select each bit in turn using a binary-weighted timing interval to generate greyscale. The advantage of this is that data is stored locally so power is not wasted continually transferring data from an external temporary memory store, thus enabling low power display of still images. However, the main disadvantage of this approach is that storing the bits in the pixel increases the area requirements of the pixel, and thus the cost of the display component.

U.S. Pat. No. 6,201,521 describes a “divided reset” scheme for addressing the pixel array. The divided reset method is best described using a simple example. Assume a pixel array has 15 rows of pixels, with each row containing 15 pixels, and with each pixel capable of storing and displaying a single bit. Also assume that 4-bit greyscale (16 grey levels) is required, so each frame time is divided into 15 equal timeslots. Having established these timeslots, a black pixel is ON for zero timeslots in a frame, a pixel with a grey level of one is on for one timeslot, a pixel with a grey level of two is ON for two timeslots, and so on up to a pixel with a grey level of 15 being ON for 15 timeslots. In this example of the divided reset method, each row is considered a reset group. It is also convenient to write data to the pixel array one row at a time, at the start (or end) of each timeslot, so that the row write function is synchronized with the PWM timeslots.

FIG. 1 illustrates how data for each row is loaded and displayed over time. Note that at the start of each timeslot, four rows must be updated. For example, at the start of timeslot 15 in FRAME 1, bit-0 data is written to ROW 15, bit-1 data is written to ROW 14, bit-2 data is written to ROW 12, and bit-3 data is written to ROW 8. Similarly, at the start of timeslot 1 in FRAME 2, bit-0 data is written to ROW1, bit-1 data is written to ROW 15, bit-2 data is written to ROW 13, and bit-3 data is written to ROW 9.

In the current state of the art, the temporary memory store for this example must hold a complete frame of data so that the four writes per timeslot can be accomplished. For the simple example given above, this corresponds to a temporary memory store with 900 bits of information, that is, 4-bits for each of the 15×15 pixels in the pixel array.

### SUMMARY OF THE INVENTION

It is an aim of the present invention to provide a circuit and method for driving electronic display pixels with a temporary memory store with much reduced memory requirements, while still maintaining high apparent bit depth greyscale.

The invention provides a circuit for driving an array of pixels according to claim 1 and an electronic display according to claim 13. Preferred or optional features of the invention are set out in the dependent claims.

### BRIEF DESCRIPTION OF THE DRAWINGS

The invention will now be described in more detail, by way of example only, with reference to the accompanying drawings, in which:

FIG. 1 schematically shows the prior art arrangement discussed above;

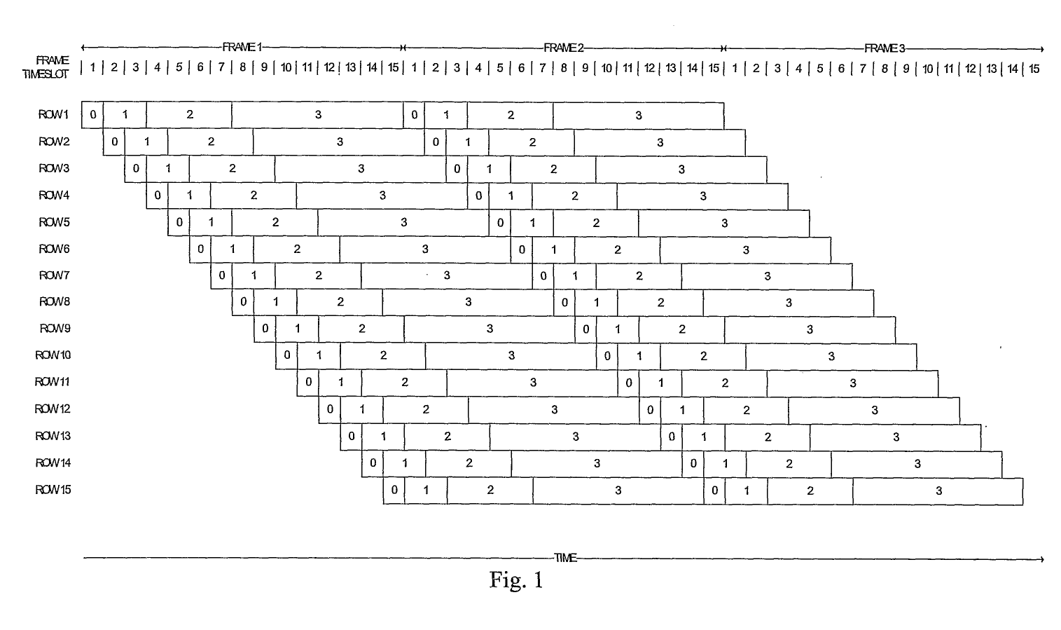

FIG. 2 schematically shows a simple embodiment of the invention; and

FIG. 3 shows the storage of data in the temporary memory circuits of FIG. 2.

### DETAILED DESCRIPTION OF PARTICULAR EMBODIMENTS

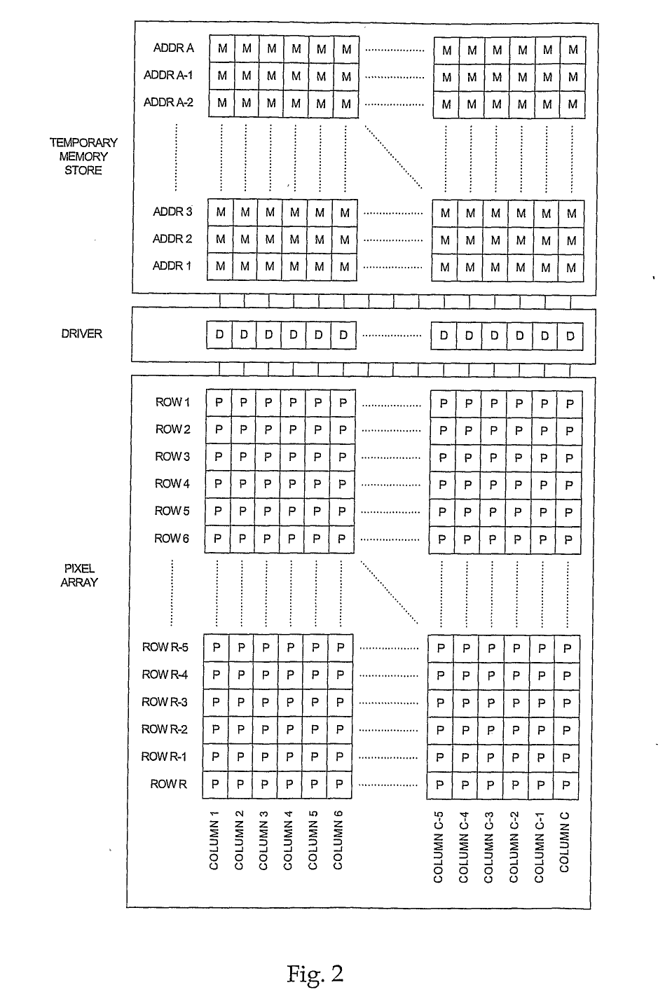

FIG. 2 shows an electronic display which comprises a pixel array 1, a temporary memory store 2, and a driver block 3. The pixel array consists of an array of pixels P with R rows and C columns. Each pixel P consists of one or more memory storage elements and an electrode driver. The pixel requires a multiplexer if the pixel has more than one memory element so that the appropriate memory element can be selected and passed as a control signal to the pixel electrode driver. The pixel electrode driver, in turn, provides a signal to control the pixel's electrode to emit or modulate light.

The temporary memory store 2 consists of a plurality of memory elements. These memory elements may be arranged in rows, designated ADDR1 to ADDR A, each with C memory elements. The number of rows A in the temporary memory store depends on the required PWM grey level bit depth, and the number of rows in the pixel array. If the required bit depth is N, then it is convenient to partition the temporary memory store 2 into (N−1) groups, where each group is associated with temporarily storing data for a specific bit weight of the required grey level bit depth. The first group is associated with temporarily storing data for the second least significant bit (bit-1), the second group is associated with temporarily storing data for third least significant bit (bit-2), and so on, up to group (N−1) being associated with temporarily storing data for the most significant bit (bit(N−1)). Alternatively, for a passive display in which the pixels do not store data, the temporary memory store may have N such groups, including a group for the least significant bit (bit-0).

The driver block 3 comprises a plurality of driver cells D. Each driver cell D may be associated with a column of pixels in the pixel array and a column of memory elements in the temporary memory store. Furthermore, each driver cell D is capable of accessing the memory element in any pixel in its associated column of pixels, and any memory element in its associated column of memory elements in the temporary memory store. Additionally, the driver block may be capable of assembling and storing up to one row of incoming N-bit video data, before the data bits are transferred to the temporary memory store and/or the pixel array.

In order to explain the principle of operation, it is convenient to use a specific example. We return to the example used above to describe the divided reset approach. As 4-bit PWM greyscale is required, it is convenient to partition each frame time into 15 timeslots. Additionally, we assume the pixel array consists of 15 rows of pixels labeled ROW 1 to ROW 15, with each row containing 15 pixels P. Additionally, each pixel P comprises a single memory element and an electrode driver, where the memory element is capable of storing 1-bit of data, and is used to control the electrode driver. Note that displays according to the invention will usually have pixel arrays far larger than 15×15 pixels and bit depths greater than 4.

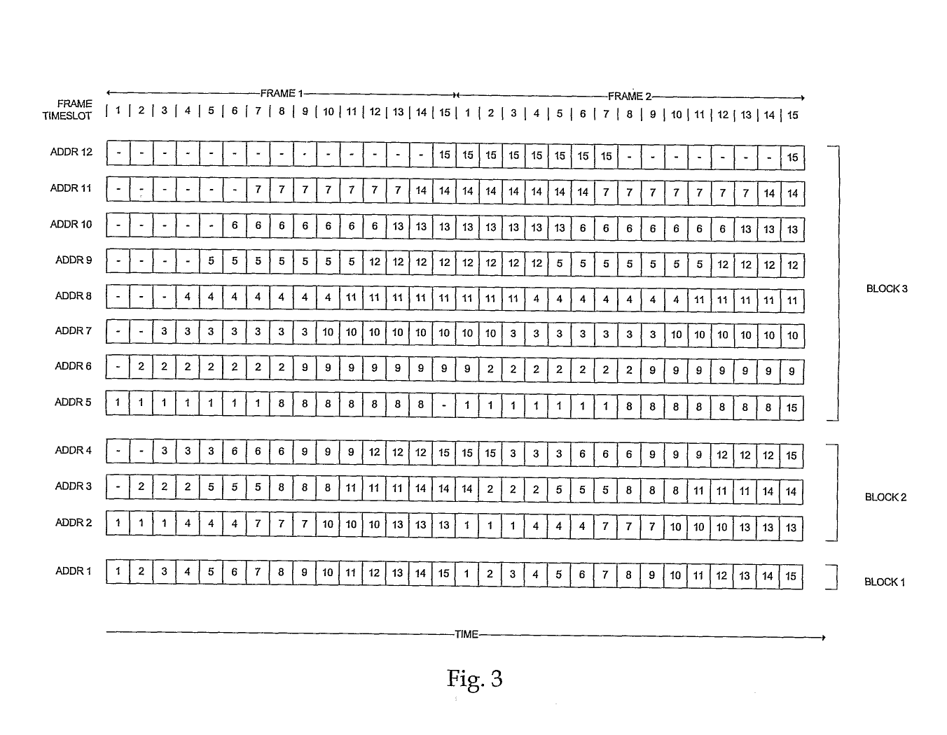

With regards to the temporary memory store of this example, as N=4, the temporary memory store may be partitioned into 3 (i.e. N−1) blocks, shown in FIG. 3. The first block, BLOCK 1, is associated with temporarily storing data for bit-1 weighted data. The second block, BLOCK 2, associated with temporarily storing data for bit-2 weighted data. The third block, BLOCK 3, is associated with temporarily storing data for bit-3 weighted data. The number of rows in each block is chosen so that each block can function as a circular buffer. For the present example, circular buffer functionality can be achieved by having one row of memory elements in BLOCK 1, three rows of memory elements in BLOCK 2, and eight rows of memory elements in BLOCK 3.

More generally, the number of rows required to permit block B to function as a circular buffer is:

$${\sum }_{b = 1}^{B} {2}^{b} - e \qquad Equation 1$$

where B is the block number (1 to N−1), and e is a correction factor (0 or 1).

More generally still, if R !=2^{N}−1, additional rows may be required.

More generally still, if the memory elements can store more than one bit, a more complex equation is required.

Now assume that the incoming 4-bit video data symbols for ROW 1 in FRAME 1 are transferred and stored at the appropriate driver cell D in the driver block until a complete row of 4-bit data symbols is established. Once established, transfer to and from the temporary memory store and pixel array can commence. Each driver D transfers bit-0 of its stored data symbol to its associated pixel in ROW 1 of the pixel array, where it can act as a control signal for its pixel electrode driver circuit. Further, each driver D also transfers bit-1 of its data symbol to its associated memory element at ADDR 1 (in BLOCK 1) of the temporary memory store. Further, each driver D also transfers bit-2 of its data symbol to its associated memory element at ADDR 2 (in BLOCK 2) of the temporary memory store. Further still, each driver D also transfers bit-3 of its ROW 1 data symbol to its associated memory element at ADDR 5 (in BLOCK 3) of the temporary memory store. Data is held in the pixel array and temporary memory store until the start of the next timeslot, while 4-bit data symbols for the ROW 2 pixels are transferred to, and stored in, the driver block.

Once the data for ROW 2 is established in the driver block, each driver D transfers bit-0 of its data symbol to its associated pixel in ROW 2 of the pixel array. Further, as pixels in ROW 1 have now displayed their bit-0's for one timeslot corresponding to the amount of time allotted to displaying the LSB using PWM, each driver D transfers the bit stored in its associated memory element at ADDR 1 to ROW 1, so that ROW 1's bit-1's can be displayed for the next two timeslots. Note that ADDR 1 of the temporary memory store is now available for re-use, so each driver D can transfer bit-1 of the ROW 2 data symbol to its associated memory element in ADDR 1. ADDR 1 thus acts as a circular buffer for bit-1 data. Further, each driver D transfers bit-2 of its data symbol to its associated memory element at ADDR 3 of the temporary memory store. Further still, each driver D transfers bit-2 of its data symbol to its associated memory element at ADDR 6 of the temporary memory store.

Similarly once data for ROW 3 is established in the driver block, each driver D transfers bit-0 of its data symbol to its associated pixel in ROW 3 of the pixel array. Further, as pixels in ROW 2 have now displayed their bit-0's for one timeslot, each driver D transfers the bit stored in its associated memory element at ADDR 1 to ROW 2, so that ROW 2's bit-1's can be displayed for the next two timeslots. Again ADDR 1 is available for re-use, so each driver D can transfer bit-1 of its ROW 3 data symbol to its associated memory element in ADDR 1. Further, each driver D, transfers bit-2 and bit-3 of its data symbol to the associated memory elements in ADDR 4 and ADDR 7 respectively of the temporary memory store.

Furthermore, once data for ROW 4 is established in the driver block, each driver D transfers bit-0 of its data symbol to its associated pixel in ROW 4 of the pixel array. Further, as pixels in ROW 3 have now displayed their bit-0's, each driver D transfers the bit stored in its associated memory element at ADDR 1 to ROW 3, so that ROW 1's bit-1's can be displayed for the next two timeslots. Again ADDR 1 is available for re-use, so each driver D can transfer bit-1 of its data symbol to its associated memory element in ADDR 1. Further, as the bit-1's for ROW 1 have now been displayed for two timeslots, corresponding to their allotted time on the PWM sequence, each driver D transfers the bit stored in its associated memory element at ADDR 2 to ROW 1, so that the ROW 1's bit-2's can be displayed for the next four timeslots. Note that ADDR 2 of the temporary memory store is now available for re-use, so each driver D can transfer bit-2 of its data symbol to its associated memory element in ADDR 2. ADDR 2 to ADDR 4 in BLOCK 2 thus act as a circular buffer for bit-2 data. Further, each driver D transfers bit-3 of its data symbol to its associated memory element at ADDR 8 of the temporary memory store.

It should be apparent that as the frame and further frames progress the number of accesses to, and from, the temporary memory store and pixel array per timeslot increases to four writes to the pixel array, interspersed with four reads from, and four writes to the temporary memory store.

Suitable apparatus can be envisaged by those skilled in the art to generate the appropriate addressing and timing control signals for this apparatus and method.

It should also be apparent that each of the blocks in the temporary memory store act as circular buffers. For the above simple example, the temporary memory store can implemented using 180 (ie. 12 rows of 15) 1-bit memory elements compared to 900 required for a full frame temporary memory store, while still maintaining the required PWM 4-bit greyscale, thus providing a substantial saving in memory requirements.

More generally, the method and apparatus described herein can also be used to implement substantial reductions in temporary memory store requirements for higher pixel count and higher bit depth display applications. For example, for a 320×240 pixel microdisplay with 8-bit greyscale, the temporary memory store can be partitioned into seven blocks, with a total of just 247 rows of 320 (1-bit) memory elements ie 79040 bits. Compared to the prior art temporary memory store with 614,400 (320×240×8) blocks, this invention provides a substantial saving in memory requirements.

In an alternative embodiment, the DATA line(s) can be partitioned into two or more separate sections, one section for the column (or row) of pixels, and the other(s) for the temporary memory store. With partitioned DATA lines, accesses to the pixel array can be performed in isolation with respect to the accesses to the temporary memory store, and accesses to the temporary memory store can be performed in isolation with respect to the accesses to the pixel array. This may reduce capacitive loading for the access circuitry, which may, in turn, provide faster access times and/or lower power dissipation. Moreover, the DATA signals can be further partitioned in two to address two sections of a row or column of pixels so as to avoid the need to send data via an entire row or column, thus improving access times and/or reducing power dissipation.

In yet another alternative embodiment, the DATA line(s) can be used to transfer analog values to and from the temporary memory store and the column (or row) of pixels. In an analog system, the invention enables lower quality memory elements (smaller or higher-leakage) to be used, and/or lower quality analog DATA line drivers, than in the prior art.

Although certain illustrative embodiments and methods have been disclosed herein, it will be apparent from the foregoing disclosure to those skilled in the art that modifications of such embodiments and methods may be made without departing from the scope of the invention as defined by the claims. For example, although the illustrative embodiments contemplate an organic light emitting diode display, the teachings of the present invention are equally applicable to liquid crystal, or other displays in which the picture elements include storage elements and are addressed individually or in a column-wise, or row-wise fashion.

In addition, the bit depth can be increased by splitting the timeslot allotted to the least significant bit into sub-timeslots. For example, in the case of the 4-bit example discussed above, splitting this timeslot into three sub-timeslots would permit an additional bit to be displayed, thus enabling 5-bit greyscale. One of the three timeslots is used for the new least significant bit, and the other two sub-timeslots are used for the old least significant bit. Similarly, splitting this timeslot into seven sub-timeslots would permit 6-bit greyscale.

1. A circuit for supplying video data supplied in frames divided into timeslots to an array of pixels, the circuit comprising a plurality of temporary storage elements, at least some of said elements being arranged to store data for different pixels of the array during different timeslots within a frame.

2. The circuit of claim 1, wherein the storage elements are digital in nature and provide a digital value to the pixel driver.

3. The circuit of claim 2, wherein the storage elements can each store one bit.

4. The circuit of claim 2, wherein the storage elements can each store more than one bit.

5. The circuit of claim 1, wherein the data is supplied to the pixels for display using a greyscale generation technique selected from pulse amplitude modulation, pulse width modulation and pulse coded modulation.

6. The circuit of claim 1, arranged to supply certain data directly to a row or column of the pixel array without storing said certain data in the temporary storage elements.

7. The circuit of claim 1, arranged to supply segments of data, each relating to a part of a row or column of the pixel array, directly to that part.

8. The circuit of claim 1, comprising driver circuits for sending data to the temporary storage elements and for transferring data from the temporary storage elements to the pixel array.

9. The circuit of claim 8, wherein the storage elements are analog in nature and can provide an analog value to the driver circuits.

10. A circuit according to claim 1, arranged to process the data on a row-by-row basis.

11. A circuit according to claim 1, arranged to process the data on a column-by-column basis.

12. A circuit according to claim 1, being an integrated circuit also comprising the array of pixels.

13. An electroluminescent display comprising an array of pixels and a circuit according to claim 1.

14. An electroluminescent display according to claim 13, wherein each pixel comprises an organic light emitting diode.

15. An electroluminescent display according to claim 13, comprising a liquid-crystal-over-silicon or a Digital Light Projector array.

16. A circuit according to claim 1, wherein the storage elements each store one bit.

17. A circuit according to claim 1, wherein the storage elements each store more than one bit.
